(19) United States
(12) Patent Application Publication
(10) Pub. No.: US 2008/0072015 A1
(43) Pub. Date: Mar. 20, 2008

(54) Demand-based processing resource allocation

(76) Inventors: Michael A. Julier, Hillsboro, OR (US); Jeffrey D. Gray, Portland, OR (US); Srinivas Chennupaty, Portland, OR (US); Sean P. Mirkes, Beaverton, OR (US); Mark P. Seconi, Beaverton, OR (US)

Correspondence Address: CAVEN & AGHEVLI;c/o INTELLEVATE, P.O. BOX 52050, MINNEAPOLIS, MN, 55402, US

(21) Appl. No.: 11/523,132

(22) Filed: Sep. 18, 2006

(51) Int. Cl. G06F 9/30

(52) U.S. Cl. 712/202

(57) ABSTRACT

A technique to dynamically enable or disable a number of stacks within a processor based on demand. At least one embodiment includes logic to detect whether a stack is needed and to enable the stack in response thereto and to disable the stack if it no longer needed.

### BACKGROUND

1. Field

The present disclosure pertains to the field of computing and computing networks, and, more specifically, to the field of allocating processing resources as they are needed.

2. Background

Microprocessors include numerous circuits, logic, and functional units that perform a variety of tasks. As more functionality is incorporated into microprocessors, the power consumption can increase accordingly. Therefore it may be advantageous to selectively disable various circuits or logic within processor from time to time, such as when they not in use. Unfortunately, enabling or disabling various circuits or logic in a processor can require time, which may effect the processor's performance. Therefore, in some processors, the choice of whether to disable a circuit or logic may depend on how quickly the circuit or logic may be re-enabled in order to perform a task without effecting performance of the processor.

For example, certain circuits, such as specialized functional units (e.g., floating point functional unit) may not be used for periods of time, but yet may remain enabled, thereby drawing unnecessary power. FIG. 1, for example, illustrates a prior art set of logic within a processor, including several execution stacks used by various other logic not shown. Particularly, FIG. 1 illustrates an integer (NT) stack, a single instruction multiple data (SIMD) stack, and floating point (FP) stack, each of which contains functional units that may be used to perform integer, SIMD, and floating point operations, respectively. The stacks may or may not contain register files that hold data for the corresponding functional units. For example, registers may be allocated for an instruction (or sub-instruction, such as a micro-operation, or “uop”) by the allocate unit and scheduled for execution by the scheduler, which may read the operand data and execute on one of the stacks depending on the type of operation. After the instruction or uop is executed, it may be retired and committed to processor state context by the retire unit.

Throughout the above-described process, one or more of the INT, SIMD and FP stacks may be enabled, thereby drawing power, even though not all of the stacks were actually used to complete the execution of the particular instruction or uop. Therefore, unnecessary power may be consumed while the instruction or uop is executing by virtue of stacks being enabled that aren't used to complete the execution of the instruction or uop. However, to disable any of the stacks may result in performance degradation if a subsequent instruction or uop requires the use of the disabled stack(s), because the disabled stack(s) may not be re-enabled fast enough to be used by the subsequent instruction or uop without the execution of the subsequent instruction or uop being delayed.

### BRIEF DESCRIPTION OF THE FIGURES

The present invention is illustrated by way of example and not limitation in the accompanying figures.

FIG. 1 illustrates a prior art set of logic used to perform various operations within a processor.

FIG. 2 illustrates a set of logic to perform various operations within a processor, according to one embodiment of the invention.

FIG. 3 illustrates a re-order buffer (ROB) that may be used in conjunction with one or more embodiments of the invention.

FIG. 4 is a flow diagram illustrating operations that may be used to perform at least some aspects of one embodiment of the invention.

FIG. 5 illustrates a shared-bus computer system in which at least one embodiment of the invention may be used.

FIG. 6 illustrates a point-to-point bus computer system in which at least one embodiment of the invention may be used.

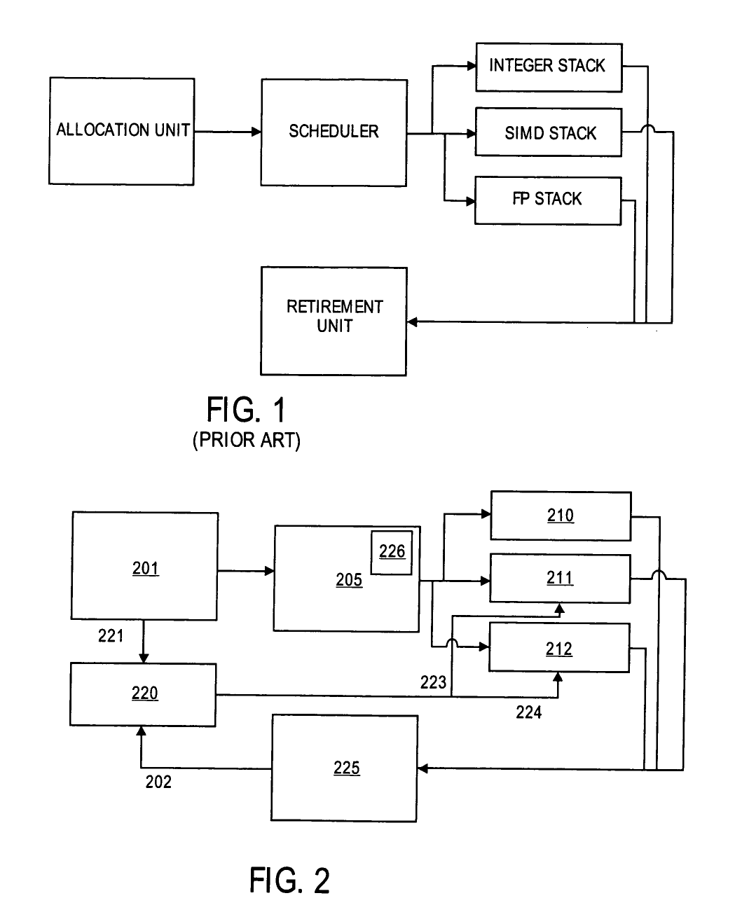

### DETAILED DESCRIPTION

Embodiments of the invention relate to processors and computer systems. More particularly, at least one embodiment of the invention relates to a technique to efficiently allocate and deallocate various processing resources based on the need for such resources.

Some embodiments of the invention allow one or more resources within a processor to be enabled or disabled based on whether or not they are needed to complete an operation, such as an instruction or uop (hereafter referred to generically as “instruction”), or “on demand”, without significantly degrading processor performance. At least one embodiment of the invention allows one or more execution structures, such as an execution stack (including one or more execution logic or resources), used by an instruction to be disabled if the performance of the instruction does not use the one or more execution structures and to re-enable the one or more stacks if a the performance of a subsequent instruction uses the stack without the subsequent instruction having to be delayed from being processed for a significant amount of time.

In particular, one embodiment enables or disables a SIMD and/or an FP stack depending upon whether an instruction being processed corresponds to a SIMD and/or an FP operation. Furthermore, one embodiment performs the detection of the whether the instruction corresponds to a SIMD and/or FP operation at a point in a processor pipeline, such that the instruction can be detected and the corresponding stack(s) enabled without the execution of the instruction having to be delayed significantly.

FIG. 2 illustrates a set of logic, according to one embodiment of the invention, in which registers are allocated for use by an instruction by an allocation unit 201, and the instruction is scheduled for execution by a scheduling unit 205. Furthermore, the logic of FIG. 2 illustrates three execution structures (e.g., stacks) to execute instructions according to an opcode associated with the instructions. In one embodiment, the execution structures correspond to an integer stack 210, a SIMD stack 211, and an FP stack 212, whereas in other embodiments, there may be fewer or more stacks, or different types of stacks. Advantageously, not all of the execution structures in FIG. 2 may be needed to perform a given instruction, and may therefore be disabled, in one embodiment of the invention. The logic of FIG. 2 also illustrates a retirement unit 225 to commit information generated by the performance of one or more instructions to processor state and/or make data available to other devices in a computer system.

In order to detect whether the performance of an instruction does not use one or more of the stacks illustrated in FIG. 2, a stack controller 220 may detect the type of instruction and enable one or more of the stacks that may be in a disabled state. Likewise, the stack controller 220 may detect when an instruction has retired, such that one or more of the stacks may be disabled after executing an instruction that used one or more of the stacks. In order to enable the one or more stacks, via signals 223 and 224, in a disabled state in time for the instruction to be executed without significantly delay, the stack controller 220 receives a signal 221 from the allocation unit 201 to inform the stack controller of whether a disabled stack will be used by the instruction being allocated. Likewise, in one embodiment, the stack controller receives a signal 202 from the retirement unit to determine when an instruction corresponding to an enabled stack has retired, such that the stack controller 220 may disable the appropriate stack(s) via signals 223 and 224. Because the stack controller 220 detects whether an instruction will use a particular stack(s) from information generated during the allocation of registers for an instruction, the corresponding stack(s) may be enabled in enough time to allow the processing of the instruction to continue without significant delay.

In one embodiment, the signal 221 is a signal indicating the type of instruction being allocated. For example, in one embodiment, the signal 221 may indicate whether the instruction being allocated corresponds to a SIMD operation or an FP operation or both. In one embodiment, whether an instruction corresponds to a SIMD or FP operation or both may be determined from various fields within the instruction. In some embodiments, other information may be signaled to the stack controller, including whether the instruction being allocated corresponds to an integer operation or some other type of operation, from which the detector may determine whether to enable a corresponding processing resource, such as the INT stack.

In one embodiment, each stack, or other resource, which is to be enabled or disabled based on the type of instruction to be processed corresponds to two bits, the state of which is controlled by the stack controller 220. For example, in the embodiment illustrated in FIG. 2, the stack controller may maintain or otherwise manipulate two bits for the SIMD stack (e.g., SIMD.valid bit and SIMD.wrap bit) and two bits for the FP stack (FP.valid bit and FP.wrap bit).

In one embodiment, the SIMD.valid bit being a first state (e.g., logical “1”), may indicate that the instruction being allocated corresponds to a SIMD operation, in which case the stack controller may enable the SIMD stack. Likewise, the FP.valid bit being in a first state (e.g., logical “1”), may indicate that the instruction being allocated corresponds to an FP operation, in which case the stack controller may enable the FP stack. In one embodiment, the SIMD.valid bit and the FP.valid bit being in a first state (e.g., logical “1”) indicates that the instruction being allocated corresponds to an SIMD FP operation, in which case the stack controller may enable the FP stack and the SIMD stack.

Conversely, the opposite logical state of the SIMD.valid and/or the FP.valid bits (e.g., “0”) may not cause the stack controller to enable the corresponding stack(s). In one embodiment, the SIMD or FP stacks may remain in the same state (enabled or disabled) they were prior to the allocation of the instruction if their corresponding bits indicate that the instruction being allocated does not correspond to an operation that uses one or both of them. In other embodiments, the stack controller may disable the stack(s) not to be used by the instruction being allocated if the stack(s) is/are in an enabled state, depending on the state of the SIMD.valid and FP.valid bits.

In addition to the SIMD.valid and FP.valid bits, the stack controller 220 may maintain two or more bits to indicate one of two generations, in which a SIMD or FP instruction may be stored in a re-order buffer (ROB) 226. In one embodiment, the ROB may be a sequentially written structure in which instructions are written in the order in which they are allocated. When the instructions are retired from the ROB, the corresponding entries may be deallocated in the order in which they were allocated.

In one embodiment, the ROB entry to be written can be tracked by a write pointer, or a “head pointer”, which increments after every ROB write operation to point to the next entry to be written. Similarly, the ROB entry to be retired can be tracked by a retire pointer or a “tail pointer”, in one embodiment, which increments after every retirement to point to the next ROB entry to be retired.

The term, “generation”, may refer to a complete traversal of the ROB by the tail pointer during which all ROB entries are retired and the tail pointer has returned back to the beginning of the ROB. Accordingly, when the tail pointer returns to the beginning of the ROB, or “wraps” back, the ROB generation may be said to have switched to the next generation. Similarly, a generation can be defined from the point of view of the head pointer, such that the generation wraps when all ROB entries are written and head pointer returns back to the beginning of the ROB. Because ROB entries may not be retired before they are written, the head pointer remains ahead of the tail pointer and hence head pointer enters a new ROB generation before the tail pointer, in one embodiment.

For example, in one embodiment a ROB may contain entries corresponding to each SIMD and/or FP instruction that is allocated by allocation unit 201 of FIG. 2. Furthermore, a field (e.g., bit storage area) in each ROB entry may be set when the corresponding SIMD or FP instruction has been retired by retirement unit 225. In one embodiment, a ROB may be indexed by pointers, including a head pointer to indicate a most recently allocated SIMD or FP instruction as well as a tail pointer to indicate the least recently allocated SIMD or FP instruction that has been retired.

In one embodiment, the ROB may toggle between two generations. Accordingly, the current generation of the ROB indicated by the tail or the head pointer can be tracked with a bit associated with the tail or head pointer itself. For example, a generation bit may toggle from a “0” to a “1” state and back to a 0 state as the corresponding pointer (tail or head) moves from a ROB generation 0 to a ROB generation 1 and back to ROB generation 0, respectively.

In one embodiment, the stack controller 220 may maintain at least two bits, such as SIMD.wrap and FP.wrap, which may be used to detect when the last SIMD or FP instruction has retired from the processor and hence there are no instructions remaining in the processor that use the SIMD or FP stack. This information can be used to power down the SIMD or FP stack, i.e., set SIMD.valid or FP.valid bits to 0, in one embodiment.

For example, when a SIMD instruction is allocated and allocator 201 sends a signal 221 to stack control 220, the SIMD.wrap bit is set to the current value of the wrap bit of the head pointer, which indicates the generation of the ROB entry written by the last SIMD instruction. When the tail pointer wraps to a new generation, the previous generation of the tail pointer is sent to the stack control 220 via signal 202. The previous ROB generation is compared against SIMD.wrap. If there is a match, this indicates that the ROB generation containing the last SIMD uop is retired and hence there are no more SIMD uops in the processor. Hence, the SIMD stack can be powered down by setting the SIMD.valid to 0, for example.

Similar operations may be applied for the FP stack vis-à-vis the FP.wrap bit, in one embodiment. Furthermore, in some embodiments, the above operations may be applied to other resources within a processor, including memory stacks or other resources that may not always be used for each instruction.

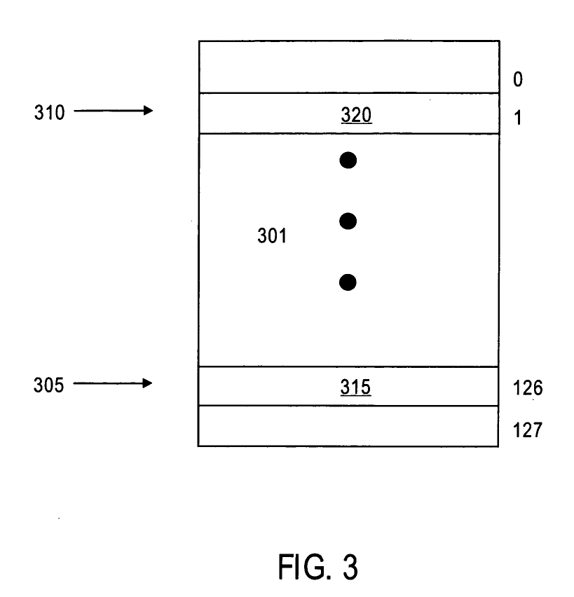

FIG. 3 illustrates a ROB and corresponding head and tail pointers that may be used in accordance with one embodiment of the invention. ROB 301 is illustrated as a 128 entry circular queue, in one embodiment, whose entries are filled from entry 0 to entry 127. Likewise, head pointer 305 and tail pointer 310 traverse from entry 0 to entry 127 and wrap around to entry 0 after they reach the last entry in the ROB. In other embodiments, the ROB may be filled from “bottom” to “top” instead of “top” to “bottom”, and the head and tail pointers may traverse the ROB accordingly.

In one embodiment, the head and tail pointers are used along with the SIMD.valid, FP.valid, SIMD.wrap, and FP.wrap bits to determine whether a corresponding stack is to be enabled or disabled. For example, if a SIMD instruction is allocated and the corresponding entry 315 stored in the ROB, head pointer 305 may point to the entry by storing the appropriate buffer entry into an appropriate field of the pointer. Likewise, the tail pointer may traverse the ROB from top to bottom until the oldest entry that has been retired 320 is found. In order to track the generation of each entry pointed to by the head and tail pointers, a bit or bits, such as a SIMD.wrap bit may be used, in conjunction with other information, by the stack controller 220 of FIG. 2.

For example, when an SIMD instruction is retired, and the ROB's tail pointer wraps, the wrap bit of the last SIMD instruction to be allocated is compared to the most recent SIMD.wrap state caused by the retirement. If they are the same then this may indicate that the last SIMD instruction allocated corresponded to the previous “generation” of the ROB traversal which has been completely retired (i.e., the previous wrap bit state belongs to an instruction of the previous traversal generation, because the wrap bit state has changed). The previous SIMD.wrap bit state being equal to the current SIMD.wrap bit state implies that the last SIMD instruction in the ROB has retired and that there are no SIMD instructions being allocated or executed. Therefore, the SIMD.valid bit may be cleared by the stack controller, and the SIMD stack disabled. A similar technique may be followed for FP instructions using corresponding FP.valid and FP.wrap bits in order to control the FP stack. Other stacks or processor resources, such as INT stack control, may be controlled using the techniques described above.

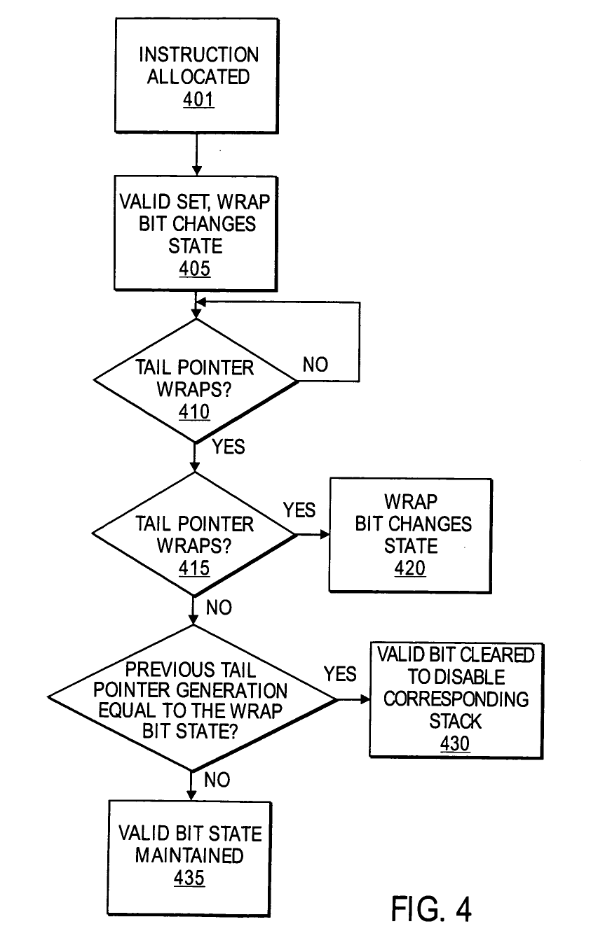

FIG. 4 is a flow diagram illustrating operations that may be used to perform some aspects of at least one embodiment of the invention. Although the flow diagram illustrates operations to control the SIMD stack, the operations described in reference to FIG. 4 may be used to control the FP stack, the SNT stack, or other processor resources. At operation 401, a SIMD instruction is allocated and, at operation 405, the corresponding SIMD.valid bit is set (if not already set) and the corresponding SIMD.wrap bit changes state based on the generation indicated by the ROB head pointer. Setting the SIMD.valid bit (if not already set) enables the SIMD stack, in one embodiment, in time for the SIMD instruction to access the SIMD stack without incurring significant delay. If the ROB tail pointer wraps, at operation 410, then if the ROB tail pointer wraps around to the beginning of the ROB at operation 415, then the generation indicated by the ROB tail pointer changes state at operation 420. The previous generation indicated by the ROB tail pointer is compared to the SIMD.wrap state at operation 425 and if they are equal, then the SIMD.valid bit is cleared to disable the SIMD stack at operation 430. In one embodiment the generation of the ROB tail pointer may be indicated by a bit or group of bits associated with the tail pointer. If they are unequal, then at operation 435, the current SIMD.valid state is maintained.

In at least one embodiment, the SIMD.wrap bit may be replaced by storing an indication of the ROB entry of the last SIMD instruction or uop to be recorded in the stack controller (via an “SIMD.robid” bit for example). In one embodiment, whenever a SIMD instruction or uop is allocated in the ROB, the SIMD.robid, for example, is updated to point to it, similar to the head pointer. When an instruction or uop retires, the retiring ROB identifier (similar to the tail pointer) may be compared to the stored SIMD.robid, and if they are equal, the SIMD.valid bit can be cleared in order to power down the corresponding stack.

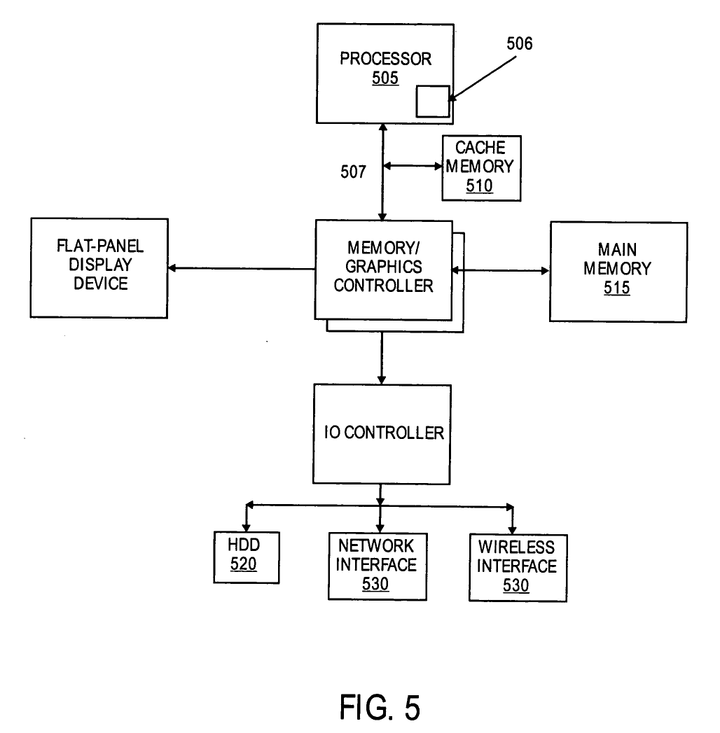

FIG. 5 illustrates a front-side-bus (FSB) computer system in which one embodiment of the invention may be used. A processor 505 accesses data from a level one (L1) cache memory 510 and main memory 515. In other embodiments of the invention, the cache memory may be a level two (L2) cache or other memory within a computer system memory hierarchy. Furthermore, in some embodiments, the computer system of FIG. 5 may contain both a L1 cache and an L2 cache.

Illustrated within the processor of FIG. 5 is a storage area 506 for machine state. In one embodiment storage area may be a set of registers, whereas in other embodiments the storage area may be other memory structures. The processor may have any number of processing cores. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 520, or a memory source located remotely from the computer system via network interface 530 containing various storage devices and technologies. The cache memory may be located either within the processor or in close proximity to the processor, such as on the processor's local bus 507.

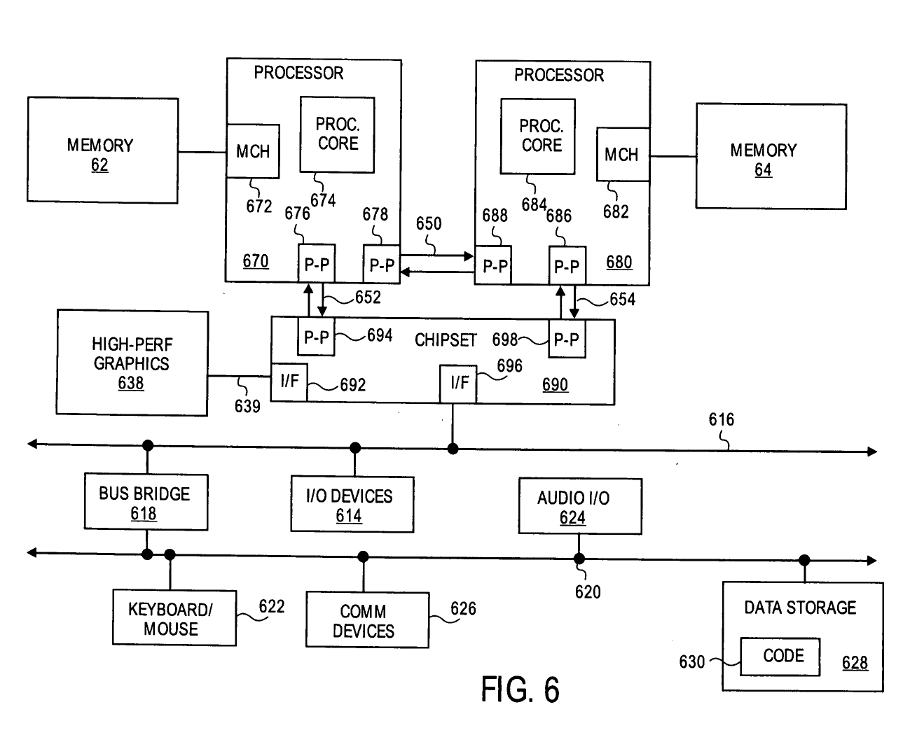

Furthermore, the cache memory may contain relatively fast memory cells, such as a six-transistor (6T) cell, or other memory cell of approximately equal or faster access speed. The computer system of FIG. 5 may be a point-to-point (PtP) network of bus agents, such as microprocessors, that communicate via bus signals dedicated to each agent on the PtP network. FIG. 6 illustrates a computer system that is arranged in a point-to-point (PtP) configuration. In particular, FIG. 6 shows a system where processors, memory, and input/output devices are interconnected by a number of point-to-point interfaces.

The system of FIG. 6 may also include several processors, of which only two, processors 670, 680 are shown for clarity. Processors 670, 680 may each include a local memory controller hub (MCH) 672, 682 to connect with memory 22, 24. Processors 670, 680 may exchange data via a point-to-point (PtP) interface 650 using PtP interface circuits 678, 688. Processors 670, 680 may each exchange data with a chipset 690 via individual PtP interfaces 652, 654 using point to point interface circuits 676, 694, 686, 698. Chipset 690 may also exchange data with a high-performance graphics circuit 638 via a high-performance graphics interface 639. Embodiments of the invention may be located within any processor having any number of processing cores, or within each of the PtP bus agents of FIG. 6.

Other embodiments of the invention, however, may exist in other circuits, logic units, or devices within the system of FIG. 6. Furthermore, in other embodiments of the invention may be distributed throughout several circuits, logic units, or devices illustrated in FIG. 6.

Processors referred to herein, or any other component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for steering memory accesses, such as loads or stores are disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

Various aspects of one or more embodiments of the invention may be described, discussed, or otherwise referred to in an advertisement for a processor or computer system in which one or more embodiments of the invention may be used. Such advertisements may include, but are not limited to news print, magazines, billboards, or other paper or otherwise tangible media. In particular, various aspects of one or more embodiments of the invention may be advertised on the internet via websites, “pop-up” advertisements, or other web-based media, whether or not a server hosting the program to generate the website or pop-up is located in the United States of America or its territories.

What is claimed is:

1. An apparatus comprising:
a stack controller to enable or disable a stack based upon whether it is to be used by an allocated instruction.

2. The apparatus of claim 1, wherein the instruction is a single-instruction-multiple-data (SIMD) instruction and the stack is a SIMD stack to perform operations associated with the SIMD instruction.

3. The apparatus of claim 1, wherein the instruction is a floating point (FP) instruction and the stack is an FP stack to perform operations associated with the FP instruction.

4. The apparatus of claim 3 further comprising a re-order buffer (ROB) to store information corresponding to allocated instructions and to indicate whether the allocated instructions have been retired.

5. The apparatus of claim 1, wherein the stack controller is to disable the stack if all instructions stored in the ROB prior to the instruction have been retired.

6. The apparatus of claim 5, wherein the stack controller is to use a first bit to indicate whether the instruction has been allocated and a second bit to indicate whether the instruction has been retired.

7. The apparatus of claim 6, wherein the first bit corresponds to a head pointer to index the most recently allocated instruction in the ROB and the second bit corresponds to a tail pointer to index a least-recently allocated instruction in the ROB that has been retired.

8. The apparatus of claim 7 further comprising an allocation unit to allocate the instruction, a scheduler to schedule the instruction, and a retirement unit to retire the instruction.

9. A system comprising:
a memory to store a first instruction and a second instruction;
a processor to detect whether a register has been allocated to either the first and second instructions and to determine whether to enable a corresponding first or second execution stack in response thereto, wherein the processor is to further determine whether to disable the first or second execution stack in response to the first or second instruction being retired.

10. The system of claim 9, wherein the processor includes an allocation unit to allocate the register to the first or second instruction.

11. The system of claim 10, wherein the processor further includes a stack controller to receive an indication from the allocation unit of whether the register has been allocated to either the first or second instruction and to enable the first or second execution stack in response thereto if the first or second execution stack is not already enabled.

12. The system of claim 11, wherein the processor further includes a retirement unit to retire the first or second instructions.

13. The system of claim 12, wherein the allocation unit is to receive an indication from the retirement unit as to whether the first or second instructions have retired.

14. The system of claim 13, wherein the processor further includes a re-order buffer whose entries are to correspond to the order in which the allocation unit allocates registers for the first and second instructions.

15. The system of claim 14, wherein the stack controller is to disable the first or second stack if the first or second instruction is the last instruction of a generation of entries within the ROB to be retired.

16. The system of claim 15, wherein the first and second instructions correspond to a single-instruction-multiple-data (SIMD) instruction and a floating-point (FP) instruction, respectively, and the first and second execution stacks correspond to a SIMD stack and an FP stack, respectively.

17. A method comprising:
allocating at least one register for a first instruction;
setting a first bit to indicate that the at least one register has been allocated;
storing an indication within a re-order buffer (ROB) of the allocation of the at least one register;
retiring the first instruction;
setting a second bit to indicate whether the first instruction is the last instruction of a first generation of ROB entries to be retired;

18. The method of claim 17 further comprising enabling a stack corresponding to the first instruction in response to the first bit being set if the stack was disabled prior to the at least one register being allocated.

19. The method of claim 17, further comprising disabling the stack in response to the first bit not being set.

20. The method of claim, wherein the ROB is to be indexed by a head pointer to point to a ROB entry corresponding to the at least one register being allocated, and wherein the ROB is to be indexed by a tail pointer to point to a ROB entry corresponding to the instruction being retired.

21. The method of claim 20, wherein the generation of ROB entries is to be indicated by a current state of the second bit in comparison to a previous state of the second bit.

22. The method of claim 21, wherein if the current state of the second bit and a previous generation ROB generation indicated by the tail pointer are the same, then the stack is to be disabled.

23. The method of claim 22, wherein the first instruction is a single-instruction-multiple data (SIMD) instruction and the stack is a SIMD stack.

24. The method of claim 22, wherein the first instruction is a floating-point (FP) instruction and the stack is-an FP stack.

25. The method of claim 22, wherein the first instruction is an integer instruction and the stack is an integer stack.

26. A processor comprising:
an allocation unit to allocate a plurality of registers corresponding to a plurality of micro-operations (uops);
a scheduler to schedule the plurality of uops to be executed;
a plurality of stacks to perform operations corresponding to the plurality of uops;
a retirement unit to retire the plurality of uops;
a stack controller to enable at least one of the plurality of stacks in response to at least one of the plurality of registers being allocated for at least one of the plurality of uops.

27. The processor of claim 26, wherein the stack controller is to disable the at least one of the plurality of stacks in response to the retirement unit retiring the at least one of the plurality of uops.

28. The processor of claim 27, further comprising a valid bit storage area to store a valid bit to indicate whether the allocation unit has allocated a stack corresponding to the at least one of the plurality of uops.

29. The processor of claim 27, further comprising a wrap bit storage area to store a wrap bit to indicate whether the at least one uop corresponds to a first generation of entries in the ROB.

30. The processor of claim 29, wherein the stack controller includes logic to determine whether a first state of the wrap bit is equal to a previous state of the wrap bit and, if the valid bit is set, the stack controller is to disable a stack corresponding to the at least one uop.
